(19) United States
(12) Patent Application Publication
(10) Pub. No.: US 2023/0044424 A1
(43) Pub. Date: Feb. 9, 2023

(54) A STABLE AGROCHEMICAL COMPOSITION AND PROCESS FOR PREPARATION THEREOF

(71) Applicants: UPL Corporation Limited, Port Louis (MU); UPL LTD, Mumbai (IN)

(72) Inventors: Ferdinando Marcos Lima Silva, Port Louis (MU); Giuvan Lenz, Port Louis (MU); Ganesh Rao, Port Louis (MU); Achintya Mondal, Mumbai (IN); Milind Jagannath Pimpale, Mumbai (IN)

(21) Appl. No.: 17/791,289

(22) PCT Filed: Jan. 6, 2021
(86) PCT No.: PCT/IB2021/050057

§ 371 Date: Jul. 7, 2022

(30) Foreign Application Priority Data
Jan. 10, 2020 (IN) 202021001276

(51) Int. Cl. A01N 57/20; A01N 25/04; A01N 37/22; A01N 33/22; A01N 43/40; B01F 23/41

(52) U.S. Cl. CPC A01N 57/20; A01N 25/04; A01N 37/22; A01N 33/22; A01N 43/40; B01F 23/4105; B01F 23/4145; B01F 2215/0477; B01F 2215/0472; B01F 2215/0468; B01F 2215/045; B01F 2101/04

(57) ABSTRACT

The present invention relates to a continuous process for preparation of a stable agrochemical composition in microreactor processing system. The present invention also provides a stable agrochemical composition having mean particle size distribution and method of controlling undesired vegetation with said composition.

### FIELD OF INVENTION

The present invention relates to a stable agrochemical composition and process for preparation of said composition. More particularly, the present invention relates to a continuous process of preparing stable agrochemical composition with narrow particle size distribution in the form of an emulsion.

### BACKGROUND OF THE INVENTION

An emulsion is a system containing two liquid phases, one of which is dispersed as globules in the other. That liquid which is broken up into globules is termed the dispersed phase or oil phase, whilst the liquid surrounding the globules is known as the continuous phase or aqueous phase. The two liquids, which must be immiscible or nearly so, are frequently referred to as the internal and external phases respectively.

An Emulsion, oil in water (EW) composition consist of a dispersion of oil droplets in a continuous aqueous medium. The EW composition is a conventional type of formulation in the field of the agrochemical formulations. EW formulations are important in agriculture as a means of formulating oil-based systems in a more environment friendly form. In the EW formulation, the emulsion is pre-formed as a commercial product and is conventionally diluted with a carrier, such as water, when making up the spray mixture for the purpose of its agricultural application.

Achieving stable EW composition is always a challenge. The stability of an EW composition refers to its ability to resist change in form and properties over time. There are three types of instability common to EW composition: (i) flocculation, (ii) creaming, and (iii) coalescence. Flocculation occurs when there is an attractive force between the droplets, so they form a flocculant mass (flocs) in the fluid through precipitation or aggregation of suspended particles. Creaming occurs when the droplets rise to the top of emulsion under the influence of buoyancy. Coalescence occurs when droplets collide and combine to form a larger droplet, so the average droplet size increases over time.

Effective emulsification is the way to overcome above mentioned instability factors. Emulsification may be regarded as a mixing operation whereby two or more normally immiscible materials are intimately mixed. Emulsification is achieved by dispersing one of the phases in the form of droplets or globules throughout the second phase. In an emulsification process, a larger droplet of oil is emulsified into large number of small droplets. The interfacial area is greatly increased as a result of the sub-division of the bulk oil into much smaller units. This large interfacial energy is accompanied by a large surface energy that is given by the product of interfacial tension and increase in surface area. This increases the total entropy of emulsion system and facilitate the emulsification process.

Based on energetics, the free energy of emulsification is positive. The first corollary of this is that emulsification is rarely a spontaneous process, and hence requires the input of energy.

This energy usually comes from mechanical shear provided by various types of mixers, and the final droplet size of the emulsion is dependent on not only the chemistry but also the amount of energy applied.

Simple paddle-type mixers are suitable when the required droplet size is above around 10 μm, but to make smaller droplets, higher shear is generally required.

High shear rotor-stator mixers are commonly used. These operate by pumping the emulsion phases through the narrow gap between a perforated cylinder (the stator) and the blades of a rapidly rotating stirrer housed inside it (the rotor) where the forces are sufficient to make droplets as small as around 1 μm.

To make even smaller droplets, at small scale, ultrasonic devices can be used to make emulsions with nanosized droplets, but they are generally not practical to scale up.

High-pressure homogenizers are readily scaled, and also produce emulsions with nanosized droplets. The emulsion phases are pumped together under high pressure into a small volume or through a small orifice (the interaction chamber) where pressures in the tens of thousands of psi (pound per square inch) create very high shear forces. Emulsions, with an average droplet size as small as 0.2 μm, can be formed this way, which is significant as these are amenable to sterilization by filtration through a 0.2 μm filter.

Most often, EW compositions are produced by milling, micronizing or high shear processing. Conventionally, EW emulsion is achieved by dissolving water soluble active ingredient in aqueous phase and oil soluble active ingredients in an oil phase and then applying energy to disperse oil phase in aqueous phase. Application of energy is required to achieve particle size of oil globules dispersed in aqueous phase to be in range of 20-500 nm. The current methods for manufacturing EW emulsions primarily rely on the reduction of particle size of agrochemically active ingredients in dry or wet formulations. Such “top-down” processes are generally slow, require repetitive processing cycles, and require substantial energy. Indeed, the targeted particle sizes, usually 1-350 nm are often time consuming and expensive to produce, frequently requiring repetitive processing cycles/passes through the milling/high shear equipment to achieve desired particle size. Moreover, another challenge in formulating EW emulsion is to achieve narrow particle size distribution which is responsible for imparting stability to the EW formulations. Narrow particle size distribution of dispersed phase with smaller particle size (ranging 1-350 nm) is highly desirable for stability of the EW emulsion.

It is very difficult by conventional methods to produce EW emulsions with narrow particle size distribution which are both easily reproducible and controlled.

### OBJECT OF THE INVENTION

It is an object of the present invention to provide a process of preparing stable agrochemical composition with narrow particle size distribution.

It is an object of the present invention to provide a process of preparing stable agrochemical composition with narrow particle size distribution in a microreactor processing system.

It is another object of the invention to provide a rapid, commercially viable process for producing stable agrochemical composition and the process is technically advanced over the conventional process.

It is another object of the present invention to provide a stable agrochemical composition with narrow particle size distribution in the form of an EW composition.

### SUMMARY OF THE INVENTION

In an aspect, present invention relates to a process of preparing stable agrochemical composition in microreactor processing system.

In another aspect a process for preparation of a stable agrochemical composition in microreactor processing system, said composition comprising:
at least one pesticide in oil phase; and
at least one more pesticide in aqueous phase;
   wherein mean particle size distribution of said stable agrochemical composition is ranging from 1 nm to 350 nm.

In another aspect is disclosed a process for preparation of a stable agrochemical composition in microreactor processing system, said composition comprising:
atleast one pesticide in oil phase selected from the group comprising of triazolinone, N-phenylphthalimide, diphenyl ether, chloroacetanilide, aryloxyphenoxypropionic acid compounds, its agrochemically compatible salts, esters and derivatives thereof; and
atleast another pesticide in aqueous phase selected from the group comprising of pyrimidinyloxybenzoic analogues, organophosphrous based compounds, bipyridinium compounds, aryloxyalkanoic acid compounds, imidazolinones and bicyclic dicarboxylic acid compounds, its agrochemically compatible salts, esters and derivatives thereof,
   wherein said stable agrochemical composition having particle size distribution ranging from 1 nm to 350 nm.

In yet another aspect is provided a process for preparing a stable agrochemical composition according to the present invention in microreactor processing system, said process comprising the steps of:
a) charging a pre-formulated oil phase in a continuous flow to a reaction vessel of microreactor;
b) charging a pre-formulated aqueous phase in a continuous flow to a reaction vessel of microreactor;
c) allowing mixing of oil phase and aqueous phase in the reaction vessel at predetermined temperature and pressure to obtain stable agrochemical composition;
   wherein obtained composition is having particle size distribution ranging from 1 nm to 350 nm.

In another aspect the present invention provides a stable agrochemical composition comprising:
a) atleast one pesticide in oil phase; and
b) atleast one pesticide in aqueous phase,
c) wherein said stable agrochemical composition has a particle size distribution ranging from 1 nm to 350 nm.

In another aspect the present invention provides a stable agrochemical composition prepared in microreactor processing system, said composition comprising:
a) atleast one pesticide in oil phase; and
b) atleast one pesticide in aqueous phase,
   wherein said stable agrochemical composition having particle size distribution ranging from 1 nm to 350 nm.

In another aspect, the present invention provides a method to control undesired plants or to influence the growth of plants, said method comprising applying to the plants or to their locus an effective amount of the composition prepared according to the present invention comprising
atleast one pesticide in oil phase; and
atleast another pesticide in aqueous phase, wherein said stable agrochemical composition having particle size distribution ranging from 1 nm to 350 nm, to the plants or to their locus.

In another aspect present invention provide use of said stable agrochemical composition having particle size distribution ranging from 1 nm to 350 nm as an herbicide to control growth of undesired plants and vegetation.

In another aspect present invention provides a kit comprising stable agrochemical composition having particle size distribution ranging from 1 nm to 350 nm according to the present invention as an herbicide.

Additional features and advantages of the present invention will be apparent from the detailed description that follows, which illustrates by way of example, the most preferred features of the present invention which are not to be construed as limiting the scope of the invention described herein.

### BRIEF DESCRIPTION OF DRAWINGS

The drawings described herein are for illustrative purposes only of selected embodiments and not all possible implementations and are not intended to limit the scope of the present disclosure.

FIG. 1 represents a diagram of a microreactor arrangement with one microreactor vessel for stable agrochemical formulation, according to one embodiment.

FIG. 2 represents intensity weighted particle size distribution of the stable agrochemical composition prepared by conventional processing system obtained by zetasizer.

FIG. 3 represents intensity weighted particle size distribution of the stable agrochemical composition prepared by microreactor processing system obtained by zetasizer.

### DETAILED DESCRIPTION OF THE INVENTION

Unless defined otherwise, all technical and scientific terms used herein have the same meaning as commonly understood by one of ordinary skill in the art to which this invention belongs. It must be noted that, as used in this specification, the singular forms “a,” “an” and “the” include plural referents unless the content clearly dictates otherwise.

As used herein, the terms “comprising” “including,” “having,” “containing,” “involving,” and the like are to be understood to be open-ended, i.e., to mean including but not limited to. The terms “preferred” and “preferably” refer to embodiments of the invention that may afford certain benefits, under certain circumstances.

In an embodiment, the aspects and embodiments described herein shall also be interpreted to replace the clause “comprising” with either “consisting of” or with “consisting essentially of” or with “consisting substantially of”.

The terms “plants” and “vegetation” include, but are not limited to, germinant seeds, emerging seedlings, plants emerging from vegetative propagules, and established vegetation.

The term “undesired plant” or “weed” refers to and includes any plant which grows where it is not wanted, including pesticide resistant plants.

The term “locus” as used herein shall denote the vicinity of a desired crop in which weed control, typically selective weed control is desired. The locus includes the vicinity of desired crop plants wherein the weed infestation has either emerged or is yet to emerge. The term crop shall include a multitude of desired crop plants or an individual crop plant growing at a locus.

The term ‘particle size’ refers to the particle size of oil phase which is in the form of dispersed oil globules in the continuous aqueous phase. The term ‘narrow particle size distribution’ refers to a particle size of more than 80% of oil phase which is in the form of dispersed oil globules in the continuous aqueous phase.

With respect to present invention the mean particle size distribution of the compositions prepared in microreactor processing system has a narrow range from 1 nm to 350 nm, preferably from 200 nm to 350 nm.

Surprisingly, inventors of the present invention found that the emulsion (EW) agrochemical composition obtained by the emulsification of biphasic system in a microreactor processing system resulted into a stable composition with narrow particle size distribution. Also, the composition prepared in microreactor processing system achieved narrow particle size distribution more rapidly than the conventional processes.

Accordingly, the present invention also allows high loads of agrochemically active ingredients with good compatibility and good stability profile. The emulsion thus obtained remained stable during storage at various temperature conditions e.g. ambient (25° C.), AHS (54° C.), 0° C. and also −5° C. (CIPAC MT 46.3 and MT 39.3) as well as upon end use while diluted with water. The stability of the present composition/formulation is demonstrated in the examples.

The present invention resides in the process for preparing said emulsions in microreactor system and the emulsion formulation having narrow particle size distribution with excellent stability and good efficacy.

The stable agrochemical composition prepared in microreactor assembly according to the present invention has a narrow particle size distribution of less than 500 nm preferably in the range from about 1 nm to about 350 nm.

The stable agrochemical composition prepared in microreactor assembly according to the present invention has a narrow particle size distribution in the range from about 100 nm to about 350 nm.

According to most preferred embodiment of the present invention, the stable agrochemical composition prepared in microreactor processing system according to the present invention has the particle size distribution in the range from about 200 nm to about 300 nm.

In an aspect the present invention provides a process for preparing a stable agrochemical composition in a microreactor processing system.

In another aspect of the present invention, there is provided a stable agrochemical composition in a microreactor processing system, said composition comprising:
atleast one pesticide in oil phase; and
atleast one pesticide in aqueous phase,
   wherein said stable agrochemical composition has particle size distribution ranging from 200 nm to 350 nm.

In another aspect of the present invention, there is provided a process for preparation of an emulsion in a microreactor processing system, said composition comprising:
atleast one pesticide in oil phase; and
atleast one pesticide in aqueous phase,
   wherein said stable agrochemical emulsion composition having particle size distribution ranging from 200 nm to 350 nm.

With preferred embodiments of this invention having been described in detail below, the design and operation of the process may now be described as follows.

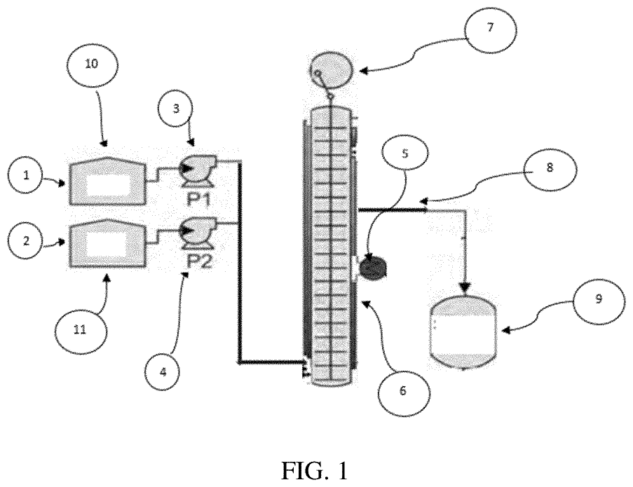

The process according to the invention will be described with reference to FIG. 1. FIG. 1 is an overall view of a system incorporating an emulsion manufacturing microreactor system according to the present invention.

Referring to FIG. 1, the process for preparation of stable agrochemical composition according to the present invention is conducted in continuous flow reactor system. The microreactor system described is a Plug Flow Reactor (PFR) with one mixing vessel unit (6), having 50 ml capacity. The mixing vessel unit (6) is designed to maintain required temperature according to conditions of the reaction in the system. The pressure element (7) is connected to the mixing vessel (6) to supply pressure adjustment externally. Heating element (5) is attached to the mixing vessel (6) that allows external setting to control the temperature and maintain required temperature. Feed containers (1) and (2) are connected to the mixing vessel (6) by tubular components known as first mixing line (10) and second mixing line (11). Feed containers (1) and (2) are connected to the mixing line (10) and mixing line (11) respectively and carries dispersed phase and aqueous phase separately to the mixing vessel (6). Pumps (3) and (4) are attached to these mixing lines (10) and (11) such that it drives the dispersed phase and aqueous phase contained in the feed containers (1) and (2) respectively to the mixing vessel (6). First mixing line (10), is connected to the mixing reaction vessel (6) via pump (3) and second mixing line (11), is connected to the mixing vessel (6) via pump (4) by directional arrow displayed. During operation, a first liquid flow into the process microreactor. The second liquid contacts and mixes with the first liquid flowing from the feed containers (1) and (2) respectively in the mixing vessel (6) to form an emulsion. The second liquid may form a discontinuous phase in the first liquid. The first liquid can form a continuous phase. The mixing vessel (6) is connected to the collector vessel (9) via receiver line (8). The emulsion flows from mixing vessel (6) is collected in the collector vessel (9).

The emulsion thus formed in the microreactor system is a stable composition.

In one embodiment, emulsion formulations can be produced within a single continuous flow reactor system. The present system can be scaled up for desired large capacity.

According to an embodiment of the present invention, the process of preparing stable agrochemical composition in microreactor processing system comprising steps of:
a) charging a pre-formulated oil phase to microreactor system through a first mixing line in a continuous flow;
b) charging a pre-formulated aqueous phase to microreactor system through a second mixing line in a continuous flow;
c) allowing mixing of oil phase and aqueous phase in the mixing vessel of microreactor system to obtain stable agrochemical composition.

The process of preparing stable agrochemical composition in microreactor processing system comprises at least one agrochemical active in oil phase and at least one another agrochemical active in aqueous phase.

In an embodiment, the composition of the present invention is an emulsion, oil in water formulation (EW) and emulsion, water in oil formulation (EO).

In a preferred embodiment, the composition of the present invention is an emulsion, oil in water formulation (EW).

According to the present invention the stable agrochemical composition obtained by this process has a particle size distribution ranging from 200 nm to 350 nm.

According to an embodiment of the present invention, an agrochemical active in oil phase is a herbicide selected from the group comprising triazolinone compounds, N-phenylphthalimide compounds, diphenyl ether compounds, chloroacetanilide compound, aryloxyphenoxypropionic acid compounds their equivalents, salts, esters, isomers and derivatives or mixtures or combinations thereof.

In an embodiment the oil phase comprises at least one herbicide in a solvent under continuous mixing; non-ionic and/or anionic surfactants and other customary adjuvants, if required to obtain pre-formulated oil phase.

According to preferred embodiment of the present invention, the oil phase is obtained by dissolving at least one herbicide selected from the group comprising of diphenyl ether herbicides, chloroacetanilide herbicide or aryloxyphenoxypropionic acid herbicides, triazolineone herbicides and imidazolinone herbicides.

According to an embodiment of the present invention, the aqueous phase comprises at least one herbicide selected from pyrimidinyloxybenzoic compounds, organophosphrous based compounds, bipyridinium compounds and imidazolinone compounds, their equivalents, salts, esters, isomers and derivatives or mixtures thereof. Preferably the aqueous phase comprises at least one herbicide in water to obtain pre-formulated aqueous phase.

According to an embodiment of the present invention, the process comprising preparation of a stable agrochemical composition in microreactor processing system and wherein said process comprising the steps of:
solubilizing atleast one pesticide and optionally, other oil soluble ingredients to obtain pre-formulated oil phase;
dissolving atleast one pesticide and other water-soluble ingredients to obtain pre-formulated aqueous phase;
feeding pre-formulated oil phase and pre-formulated aqueous phase in a micro-reactor assembly;
allowing the pre-formulated oil phase and pre-formulated aqueous phase to mix at pre-determined pressure and temperature in a micro-reactor assembly to obtain stable agrochemical composition
wherein said composition is having mean particle size distribution ranging from 200 nm to 350 nm.

According to an embodiment of the present invention, a process for preparation of a stable agrochemical composition in microreactor processing system comprising:
solubilizing S-metolachlor and optionally other oil soluble ingredients to obtain pre-formulated oil phase;
separately, dissolving glufosinate-ammonium and other water-soluble ingredients to obtain pre-formulated aqueous phase;
feeding pre-formulated oil phase and pre-formulated aqueous phase in a micro-reactor assembly;
permitting pre-formulated oil phase and pre-formulated aqueous phase to mix at pre-determined pressure and temperature in a micro-reactor assembly to obtain stable agrochemical composition with mean particle size distribution ranging from 200 nm to 350 nm.

According to an embodiment of the present invention, a process for preparation of a stable agrochemical composition in microreactor processing system comprising:
solubilizing oxyfluorfen and optionally other oil soluble ingredients to obtain pre-formulated oil phase;
separately, dissolving glufosinate-ammonium and other water-soluble ingredients to obtain pre-formulated aqueous phase;
flowing pre-formulated oil phase and pre-formulated aqueous phase in a micro-reactor assembly;
allowing pre-formulated oil phase and pre-formulated aqueous phase to mix at pre-determined pressure and temperature in a micro-reactor assembly to obtain stable agrochemical composition with mean particle size distribution ranging from 200 nm to 350 nm.

According to an embodiment of the present invention, a process for preparation of a stable agrochemical composition in microreactor processing system comprising:
solubilizing haloxyfop-P-methyl and optionally other oil soluble ingredients to obtain pre-formulated oil phase;
separately, dissolving glufosinate-ammonium and other water-soluble ingredients to obtain pre-formulated aqueous phase;
flowing pre-formulated oil phase and pre-formulated aqueous phase in a micro-reactor system;
permitting pre-formulated oil phase and pre-formulated aqueous phase to mix at pre-determined pressure and temperature in a micro-reactor assembly to obtain stable agrochemical composition with mean particle size distribution ranging from 200 nm to 350 nm.

According to an embodiment of the present invention, a process for preparation of a stable agrochemical composition in microreactor processing system/assembly is a continuous process.

According to an embodiment of the present invention, a process of preparing stable agrochemical composition in microreactor processing system is carried out in a reactor selected from Spinning Disk Reactor (SDR), Plug Flow Reactors (PFR), Micro Channels, Meso Channel Plates, Continuous Stirring Tank Reactor (CSTR), Shaken Tube or Oscillatory Flow Tubes.

According to an embodiment of the present invention, a process of preparing stable agrochemical composition in microreactor processing system is carried out in Spinning Disk Reactor (SDR).

According to an embodiment of the present invention, a process of preparing stable agrochemical composition in microreactor processing system is carried out in Plug Flow Reactors (PFR).

According to an embodiment of the present invention, the rate of flow of pre-formulated oil phase in first mixing line is ranging from about 0.1 g/min to about 10 g/min.

According to preferred embodiment of the present invention, the rate of flow of pre-formulated oil phase in first mixing line is ranging from about 2 g/min to about 6 g/min.

According to an embodiment of the present invention, the rate of flow of pre-formulated aqueous phase in second mixing line is ranging from about 0.1 g/min to about 4000 g/min.

According to preferred embodiment of the present invention, the rate of flow of pre-formulated aqueous phase in second mixing line is ranging from about 2 g/min to about 3000 g/min.

Choice of mixing vessel capacity depends on the amount of stable composition to be prepared. According to an embodiment of the present invention, capacity of mixing vessel varies from 0.1 ml to 1000 ml.

According to a preferred embodiment of the present invention, mixing vessel is a spinning disc type reactor having rotating disc in a collection tank. The surface area available for mass transfer is roughly equal to the surface area of the disc, and a moderate amount of shear in the liquid film enhances mass transfer. The residence time in the reactor does greatly depend on the spinning rate of the disc, so that higher shear comes at the cost of shorter residence times.

According to an embodiment of the present invention, residence time of pre-formulated oil phase and pre-formulated aqueous phase reactants in the reaction vessel to prepare said stable agrochemical composition is from about 30 seconds to 1 hour.

According to an embodiment of the present invention, mixing vessel receives pre-formulated oil phase from first mixing line and pre-formulated aqueous phase from second mixing line simultaneously or sequentially to facilitate mixing of oil phase and aqueous phase under pre-determined temperature and pressure.

According to an embodiment of the present invention, temperature of the mixing vessel is ranging from about 1° C. to about 50° C.

According to preferred embodiment of the present invention, temperature of the mixing vessel is ranging from about 10° C. to about 40° C.

According to an embodiment of the present invention, temperature of the mixing vessel is ranging from about 20° C. to about 30° C.

According to an embodiment of the present invention, pressure of the mixing vessel is ranging from about 0.1 to about 20 bar.

According to preferred embodiment of the present invention, pressure of the mixing vessel is ranging from about 1 to about 10 bar.

According to an embodiment of the present invention, residence time to facilitate efficient mixing of oil phase and aqueous phase to obtain stable agrochemical composition is less than 30 minutes.

According to an embodiment of the present invention, residence time to facilitate efficient mixing of oil phase and aqueous phase to obtain stable agrochemical composition is less than 10 minutes.

According to an embodiment of the present invention, residence time to facilitate efficient mixing of oil phase and aqueous phase to obtain stable agrochemical composition is less than 1 minute.

In an aspect the present invention provides a stable agrochemical composition comprising:
atleast one pesticide in oil phase; and
atleast one pesticide in aqueous phase,
   wherein said stable agrochemical composition has narrow mean particle size distribution ranging from 200 nm to 350 nm.

According to an embodiment of the present invention, the pesticide in oil phase of the stable agrochemical composition is selected from the group comprising of triazolinone, N-phenylphthalimide, diphenyl ether, chloroacetanilide, aryloxyphenoxypropionic acid compounds, its agrochemically compatible salts, esters and derivatives thereof.

According to an embodiment of the present invention, the pesticide in oil phase of the stable agrochemical composition is selected from the group comprising of diphenyl ethers, chloroacetanilide compounds, aryloxyphenoxypropionic acid compound, imidazolinones, carbamates, thiocarbamates, haloacetanilides, phenoxycarboxylic acid derivatives, triazolinones, N-phenylphthalimide herbicides, heteroaryloxyphenoxy-alkanecarboxylic acid derivatives such as aryloxyphenoxy, quinolyloxy, quinoxalyloxy, pyridyloxy, benzoxalyloxy and benzothiazoleyloxyphenoxyalkanecarboxylic esters, cyclohexanedione derivatives, pyrimidyloxypyridinecarboxylic acid derivatives, pyrimidyloxybenzoic acid derivatives, sulfonylureas, triazoleopyrimidinesulfonamide derivatives, and S-(Naryl-N-alkylcarbamoylmethyl)dithiophosphoric ester compounds and salts or mixtures of such pesticides.

According to certain embodiments of the present invention, the pesticide in oil phase is selected from diphenyl ether compound, chloroacetanilide compound or aryloxyphenoxypropionic acid compound, triazolineone compound and imidazolinone compound.

According to an embodiment of the present invention, the pesticide n an oil phase is selected from the group comprising of diphenyl ether compound, chloroacetanilide compound or aryloxyphenoxypropionic acid compounds.

According to an embodiment of the present invention, the pesticide in an oil phase is selected from diphenyl ether compounds, their equivalents, metabolites, salts, esters, isomers and derivatives compounds thereof.

According to an embodiment of the present invention, diphenyl ether compound include ethoxyfen, acifluorfen, aclonifen, bifenox, chlomethoxyfen, chlornitrofen, etnipromid, fluorodifen, fluoroglycofen fluoronitrofen, fomesafen, fucaomi, furyloxyfen, halosafen, lactofen, nitrofen, nitrofluorfen, oxyfluorfen their equivalents, metabolites, salts, esters and derivative compounds.

According to preferred embodiment of the present invention the diphenyl ether compound is oxyfluorfen.

According to an embodiment of the present invention, pesticide in an oil phase selected from chloroacetanilide compounds, their equivalents, metabolites, salts, esters, isomers and derivatives thereof.

According to an embodiment of the present invention, chloroacetanilide compounds include acetochlor, alachlor, butachlor, butenachlor, delachlor, diethatyl, dimethachlor, ethachlor, ethaprochlor, metazachlor, metolachlor, S-metolachlor, pretilachlor, propachlor, propisochlor, prynachlor, terbuchlor, thenylchlor, xylachlor.

According to preferred embodiment of the present invention the chloroacetanilide compound is selected from metolachlor or S-metolachlor.

According to an embodiment of the present invention, pesticide in an oil phase selected from aryloxyphenoxypropionic acid compounds, their equivalents, metabolites, salts, esters, isomers and derivatives thereof.

According to an embodiment of the present invention, aryloxyphenoxy propionic acid compounds include chlorazifop, clodinafop, clofop, cyhalofop, diclofop, fenoxaprop fenoxaprop-P, fenthiaprop, fluazifop, fluazifop-P, haloxyfop, haloxyfop-P, haloxyfop-P methyl, isoxapyrifop, kuicaoxi, metamifop, propaquizafop, quizalofop, quizalofop-P and trifop.

In certain embodiment of the present invention the aryloxyphenoxypropionic acid compounds are selected from haloxyfop, and its isomers or its derivatives such as esters.

In another embodiment of the present invention the aryloxyphenoxypropionic acid compound is haloxyfop-P methyl.

According to an embodiment of the present invention, the stable agrochemical composition comprising from about 0.1% to about 90% w/w and preferably from about 1% to about 70% w/w of pesticide in oil phase of the total weight of the stable agrochemical composition.

According to a preferred embodiment of the present invention, the stable agrochemical composition comprising from about 10% to about 50% w/w of pesticide in oil phase of the total weight of the stable agrochemical composition.

According to an embodiment of the present invention, pesticide in oil phase of the stable agrochemical composition is selected from the group comprising of acetochlor, alachlor, ametryn, amidosulfuron, anilofos, atrazine, azafenidin, azimsulfuron, benfluralin, benfuresate, bensulfuron-methyl, bensulide, benzfendizone, benzofenap, bromobutide, bromofenoxim, butachlor, butafenacil, butamifos, butralin, butylate, cafenstrole, carbetamide, chlorbromuron, chloridazon, chlorimuron-ethyl, chlorotoluron, chlorpropham, chlorsulfuron, chlorthal-dimethyl, chlorthiamid, cinidon-ethyl, cinmethylin, cinosulfuron, clomazone, clomeprop, cloransulam-rnethyl, cyanazine, cycloate, cyclosulfamuron, daimuron, desmedipham, desmetryn, dichlobenil, diflufenican, dimefuron, dimepiperate, dirnethachlor, dimethametryn, dimethenamid, dinitramine, dinoterb, diphenamid, dithiopyr, diuron, EPTC, esprocarb, ethalfiuralin, ethametsulifuron-methyl, ethofumesate, ethoxysulfuron, etobenzanid, ferioxaprop-ethyl, fenuron, flamprop-methyl, flazasulfuron, fluazolate, fluchloralin, flumetsulam, flumiclorac-pentyl, flumioxazin, fluometuron, fluorochloridone, flupoxam, flurenol, fluridone, fluroxypyr-1-methylheptyl, flurtamone, fluthiacet-methyl, halosulfuron, hexazinone, imazosulfuron, indanof an, isoproturon, isouron, isoxaben, isoxaiflutole, lenacil, linuron, mefenacet, metamitron, metazachlor, methabenzthiazuron, methyldymron, metobenzuron, metobromuron, metolachlor, metosulam, metoxuron, metribuzin, metsulifuron, molinate, monolinuron, naproanilide, napropamide, neburon, nicosulfuron, norfiurazon, orbencarb, oryzalin, oxadiargyl, oxadiazon, oxasulfuron, pebulate, pendimethalin, pentanochlor, pentoxazone, phenmedipham, piperophos, pretilachlor, primisulfuron, prodiamine, profluazol, prometon, prometryn, propachlor, propanhl, propazine, propham, propisochlor, propyzamide, prosulfocarb, prosulfuron, pyraflufen-ethyl, pyrazogyl, pyrazolynate, pyrazosulfuron-ethyl, pyrazoxyfen, pyributicarb, pyridate, pyriminobac-methyl, quinclorac, quinmerac, rimsulfuron, siduron, simazine, simetryn, sulcotrione, sulfentrazone, sulfometuron, sulfosulfuron, tebutam, tebuthiuron, terbacil, terbumeton, terbuthylazine, terbutryn, thenyichlor, thiazopyr, thidiazimin, thifensulfuron, thiobencarb, tiocarbazil, triallate, triasulfuron, tribenuron, trietazine, trifluralin, triflusulfuron and vernolate and salts or mixtures of such herbicides.

According to an embodiment of the present invention, the pesticide in aqueous phase of the stable agrochemical composition is selected from the group comprising of pyrimidinyloxybenzoic compounds, organophosphorous based compounds, bipyridinium compounds, aryloxyalkanoic acid compounds, imidazolinones and bicyclic dicarboxylic acid compounds and salts or mixtures of such pesticides, their equivalents, metabolites, salts, esters, isomers and derivatives thereof.

According to an embodiment of the present invention, the pesticide in aqueous phase of the stable agrochemical composition is selected from the group comprising of lactofen, fomesafen, pyrithiobac sodium, bispyribac sodium; glyphosate, glufosinate, glufosinate-P, bilanafos, bialaphos, paraquat, diquat, 2,4-D, MCPA, MCPB, triclopyr, pichloram, aminopyralid, dicamba, 2,3,6-TBA, tricamba, clopyralid; imazameth, imazamethabenz, imazamox, imazapic, imazapyr, imazaquin, imazethapyr; endothal and salts or isomers or mixtures of such pesticides.

According to preferred embodiment of the present invention, the herbicide in aqueous phase is glufosinate, all stereoisomers and salts, for example, D,L-2-amino-4-[hydroxy(methyl)-phosphinyl]butanoic acid (DL-glufosinate), glufosinate ammonium salt, glufosinate sodium salt, glufosinate potassium salt, L-glufosinate, L-glufosinate sodium salt, L-glufosinate ammonium salt, L-glufosinate potassium salt.

According to most preferred embodiment of the present invention, herbicide in aqueous phase is glufosinate ammonium salt, or L-glufosinate ammonium salt, or their mixtures and salts thereof.

According to an embodiment of the present invention, the stable agrochemical composition comprising from about 0.1% to about 90% w/w and preferably from about 1% to about 70% w/w of pesticide dissolved in aqueous phase of the total weight of the stable agrochemical composition.

According to preferred embodiment of the present invention, the stable agrochemical composition comprising from about 10% to about 50% w/w of pesticide dissolved in aqueous phase of the total weight of the stable agrochemical composition.

According to an embodiment of the present invention, the stable agrochemical compositions according to the present invention may optionally include adjuvants/auxiliary agents commonly used in agricultural formulations and known to those skilled in the art. Examples include surfactants, solvent, fertilizer, pH modifiers, crystallization inhibitors, viscosity modifiers, suspending, agents, spray droplet modifiers, pigments, antioxidants, foaming agents, light-blocking agents, antifoam agents, sequestering agents, neutralizing agents, corrosion inhibitors, dyes, odorants, spreading agents, penetration aids, micronutrients, emollients, lubricants, sticking agents, dispersing agents, wetting agent, thickening agents, freezing point depressants, antimicrobial agents, and the like.

According to an embodiment of the present invention, stable agrochemical composition comprises of one or more organic solvents. With respect to the present invention the term ‘organic solvent’, refers to polar or nonpolar organic solvents.

Examples of polar or non-polar organic solvents are aliphatic or aromatic hydrocarbons for example Aromatic C-9, Solvent naphtha, Solvesso 100, Solvesso150 and Solvesso 200, their derivatives, halogenated aliphatic or aromatic hydrocarbons, ethers, polyhydric alcohols, alkylene glycols, alkyleneglycol monoalkyl ethers such as propylene glycol monomethyl ether, spicosolve and dialkyl ethers, amides such as Rhodiasolv ADMA 10, ADMA 810, ketones for example cyclohexanone or isophorone, glycerol and glycerol esters such as glycerol triacetate, N-methylpyrrolidone, nitriles and sulfoxides and or combinations thereof.

According to another embodiment the solvents are selected from oils of vegetable or animal origin or their derivatives. Examples of oils include soyabean oil, epoxidized soybean oil, linseed oil, rapeseed oil, canola oil, olive oil or sunflower oil, emulsified vegetable oil, corn oil, its concentrates and Tower alkyl derivatives thereof.

Alkyl esters of oils of vegetable origin such as, for example, the methyl derivatives, or an oil of animal origin such as fish oil or beef tallow. Esters of plant oils are alkyl esters obtainable from medium chained fatty acids by esterification with alkanols or by transesterification of the corresponding plant oils. Examples of methyl ester of fatty acids and vegetable oil are methyl ester of soyabean oil, methyl ester of canola oil, Steposol C-65, Steposol C-25 and Steposol C-42.

In a preferred embodiment of the present invention, the stable agrochemical composition comprises aromatic hydrocarbon solvents selected from Aromatic C-9, ADMA 810, ADMA 10, Xylene, Solvesso 100, Solvesso 150, and Solvesso 200 or combinations thereof.

According to another embodiment of the present invention, the stable agrochemical composition comprises from about 1% to about 50% and preferably from about 5% to about 40% solvents of the total weight of the stable agrochemical composition.

In a preferred embodiment of the present invention, the stable agrochemical composition comprises from about 1% to about 30% solvents of the total weight of the stable agrochemical composition.

According to an embodiment of the present invention, the stable agrochemical composition comprises one or more surfactants selected from the group comprising of anionic and non-ionic surfactants.

Non-limiting examples of anionic surfactants include are phosphate esters and sulfate esters of poly (preferably 2 to 30) ethoxylated (preferably C₆ to C₂₂) fatty alcohols such as ethoxylated (2 EO (EO means an ethylene oxide unit) oleyl alcohol phosphate ester, ethoxylated oleyl alcohol phosphate esters, ethoxylated (2-10 EO) ceto/stearyl alcohol phosphate esters, ethoxylated (4-6 EO) tridecyl alcohol phosphate esters, ethoxylated fatty alcohol phosphate ester, ethoxylated (3-6 EO) fatty alcohol phosphate esters, free acids of complex organic phosphate esters, phosphate esters of polyethoxylated (8 to 25 EO) such as Stepfac TSP-PE-N, arylphenols (such as polyethoxylated di- and tristyrylphenols) (e.g. Soprophor), sulfate esters of polyethoxylated (8 to 25 EO) arylphenols (such as polyethoxylated di- and tristyrylphenols) (e.g. Soprophor DSS/7®, Soprophor 4D384®), inorganic salts of alkylbenzenesulfonate (such as calcium dodecylbenzenesulfonate) or inorganic salts of polycarboxlic acids, such as sodium and potassium salts, Geropon T77® (Rhodia) Reax 825® (Westvaco) (ethoxylated lignin sulfonate); Stepfac 8171® (Stepan) (ethoxylated nonylphenol phosphate ester); Ninate 401-A® (Stepan) (calcium alkylbenzene sulfonate); Emphos CS-131® (Witco) (ethoxylated nonylphenol phosphate ester); and Atphos 3226® (Uniqema) (ethoxylated tridecylalcohol phosphate ester) or combinations thereof.

Non-limiting examples of non-ionic surfactants include ethoxylated branched alcohols (e.g. Genapol® X-type) with 2-20 EO units; methyl end-capped, ethoxylated branched alcohols (e.g. Genapol® XM-type) comprising 2-20 EO units; ethoxylated coconut alcohols (e.g. Genapol® C-types) comprising 2-20 EO units; polyethoxylates, polyether alcohols, branched secondary alcohol ethoxylates (Tergitol™ TMN series, Dow Chemical, Midland, Mich.), ethylene oxide/propylene oxide copolymers (Tergitol™ L Series, Tergitol™ XD, XH, XJ and Dow Chemical, Midland, Mich.), nonylphenol ethoxylates (Tergitol™ NP Series, Dow Chemical, Midland, Mich.), octylphenol ethoxylates (Triton™ X Series, Dow Chemical, Midland, Mich.), secondary alcohol ethoxylates (Tergitol™ 15-S Series, Dow Chemical, Midland, Mich.), glycol esters, triglyceride ethoxylates, alkanolamides, sorbitan ester ethoxylates, linear and branched alcohol alkoxylates, polyalkylene oxide block copolymer (Atlox G5000 and G5000L series), fatty alcohol ethoxylates, organomodified polysiloxanes, e.g. BreakThru® OE444, BreakThru® S240, Silwett® L77, Silwett® L408, Silwet® L806; Vegetable oil ethoxylates (Alkamuls VO/2003®, Alkamuls PSTO 20®, Alkamuls 400DO®, (Alkamuls SML®); polyethoxylated (30 to 40 EO) castor oils, polyethoxylated (6 to 20 EO) fatty (C₈ to C₂₂) alcohols, polyethoxylated (8 to 25 EO) arylphenols (such as polyethoxylated di- and tristyrylphenols (Soprophore BSU), tridecyl alcohol polyglycol ethers (such as ethoxylated (6 EO) tridecyl alcohol: Genapol® X-060, Clariant, Germany) polyalkoxylated alkyl ethers (such as polyalkoxylated butyl ether: Witconol® NS 500 K, CK Witco, USA), ethylene oxide propylene oxide block copolymers (molecular weight ranging from 4,000 to 20,000 preferably ranging from 6,500 to 15,000) or combinations thereof.

According to another embodiment of the present invention, the stable agrochemical composition comprises from surfactants from about 0.1% to about 30% and preferably from about 0.5% to about 20% of the total weight of the stable agrochemical composition.

In a preferred embodiment of the present invention, composition comprises surfactants from about 1% to about 15% of the total weight of the stable agrochemical composition.

According to another embodiment of the present invention, stable agrochemical composition further comprises one or more film-forming agent/thickener. Examples of suitable film-forming agents/thickeners are thermoplastic resins such as polyvinyl pyrrolidone, polyvinyl alcohols, and or vinylpyrrolidone/vinyl acetate copolymers.

According to another embodiment of the present invention, stable agrochemical composition comprises film-forming agents/thickeners generally added in an amount from about 0.1% to 5.0% w/w, preferably from about 0.5 to about 3.0% w/w.

According to another embodiment of the present invention, stable agrochemical composition, optionally comprises further additives or auxiliaries, preferably antifreeze agents, stabilizing agents, antifoams and defoamers, preservatives, colouring agents and/or odour masking products.

Examples of suitable antifreeze agents are ethylene glycol, monopropylene glycol, glycerol, hexylene glycol, 1-methoxy-2-propanol, cyclohexanol, in particular monopropylene glycol.

They are optionally added in an amount, preferably from about 0.1% to about 30% w/w, particularly from about 1% to about 15% w/w of total weight of the stable agrochemical composition.

Stabilizing agents which are optionally added in the formulation are acids, preferably organic acids, such as dodecylbenzene sulfonic acid, acetic acid, propionic acid or citric acid, in particular citric acid and antioxidants, such as butyl hydroxy toluene (BHT), butyl hydroxy anisole (BHA), in particular butyl hydroxy toluene.

The stabilizing agent is optionally added in an amount of generally from about 0.01% to about 2% w/w, particularly from about 0.1% to about 1% w/w of total weight of the stable agrochemical composition.

Preferred antifoams and defoamers are based on silicone, particularly preferred are an aqueous emulsion of dialkylpolysiloxanes commercially available as Rhodorsil® 426R, Wacker SE series, and a mixture of dialkylpolysiloxanes as an oil, commercially available as Rhodorsil® 416, Wacker S184 or Wacker SL.

The antifoams/defoamers are optionally added in an amount from about 0.01% to about 2% w/w, preferably from about 0.1% to about 1.5% w/w of total weight of the stable agrochemical composition.

The preservatives are optionally added such as, derivatives of benzoic acid, sorbic acid, formaldehyde, in particular a combination of methyl parahydroxybenzoate or propyl parahydroxybenzoate, generally in an amount from about 0.1% to about 1.0% w/w, particularly from about 0.2% to about 0.5% w/w.

Further preferred optional additives are colouring agents such and odour masking products such as a mixture of numerous natural and synthesis perfumes, such as Perfume® TM 4242.

The additives are optionally added in amounts of generally, from about 0.01% to about 1% w/w, particularly from about 0.1% to about 0.5% w/w of colouring agent and from about 0.02% to about 2% by weight, particularly from about 0.1% to about 1% by weight of odour masking products.

The stable agrochemical composition according to the present invention comprises at least 5% by weight, preferably at least 10% by weight and especially preferably at least 15% by weight of water based on the total weight of the stable agrochemical composition.

The stable agrochemical composition according to the invention comprises from about 5% to about 70% w/w, preferably from about 10% to about 60% w/w and especially preferably from about 15% to about 50% w/w of water, based on the total weight of the stable agrochemical composition.

According to an embodiment of the present invention there is provided a stable agrochemical composition prepared in microreactor processing system with narrow particle size distribution ranging from 200 nm to 350 nm, comprises glufosinate ammonium, oxyfluorfen, solvent and non-ionic and/or anionic surfactants.

Accordingly, the stable agrochemical composition prepared in microreactor processing system with narrow particle size distribution ranging from 200 nm to 350 nm, comprises from about 0.1% to about 90% by weight of glufosinate ammonium, from about 0.1% to about 90% by weight of oxyfluorfen, from about 1% to about 50% by weight of solvent and from about 0.1% to about 30% by weight of non-ionic and/or anionic surfactants.

Accordingly, the stable agrochemical composition prepared in microreactor processing system with narrow particle size distribution ranging from 200 nm to 350 nm, comprises from about 0.1% to about 50% by weight of glufosinate ammonium, from about 0.5% to about 40% by weight of oxyfluorfen, from about 1% to about 30% by weight of solvents and from about 1% to about 10% by weight of non-ionic and anionic surfactants.

Accordingly, the stable agrochemical composition prepared in microreactor processing system with narrow particle size distribution ranging from 200 nm to 350 nm, comprises from about 0.1% to about 50% by weight of glufosinate ammonium, from about 0.5% to about 40% by weight of oxyfluorfen, from about 1% to about 30% by weight of solvents and from about 1% to about 10% by weight of non-ionic and anionic surfactants is in the form of an Emulsion, oil in water formulation (EW).

According to an embodiment of the present invention there is provided a stable agrochemical composition prepared in microreactor processing system with narrow particle size distribution ranging from 200 nm to 350 nm, comprises glufosinate ammonium, S-metolachlor, solvent and non-ionic and/or anionic surfactants.

Accordingly, the stable agrochemical composition prepared in microreactor processing system with narrow particle size distribution ranging from 200 nm to 350 nm, comprises from about 0.1% to about 90% by weight of glufosinate ammonium, from about 0.1% to about 90% by weight of s-metolachlor, from about 1% to about 50% by weight of solvent and from about 0.1% to about 30% by weight of non-ionic and/or anionic surfactants.

Accordingly, the stable agrochemical composition prepared in microreactor processing system with narrow particle size distribution ranging from 200 nm to 350 nm, comprises from about 10% to about 50% by weight of glufosinate ammonium, from about 10% to about 50% by weight of s-metolachlor, from about 1% to about 30% by weight of solvents and from about 5% to about 20% by weight of non-ionic and anionic surfactants.

Accordingly, the stable agrochemical composition prepared in microreactor processing system with narrow particle size distribution ranging from 200 nm to 350 nm, comprises from about 10% to about 50% by weight of glufosinate ammonium, from about 10% to about 50% by weight of s-metolachlor, from about 1% to about 30% by weight of solvents and from about 5% to about 20% by weight of non-ionic and anionic surfactants is in the form of an Emulsion, oil in water formulation (EW).

According to an embodiment of the present invention there is provided a stable agrochemical composition developed in microreactor processing system having particle size distribution ranging from 200 nm to 350 nm, comprises glufosinate ammonium, haloxyfop-p-methyl, solvent and non-ionic and/or anionic surfactants.

Accordingly, the stable agrochemical composition prepared in microreactor processing system with narrow particle size distribution ranging from 200 nm to 350 nm, comprises from about 0.1% to about 90% by weight of glufosinate ammonium, from about 0.1% to about 90% by weight of haloxyfop-p-methyl, from about 1% to about 50% by weight of solvent and from about 0.1% to about 30% by weight of non-ionic and/or anionic surfactants.

Accordingly, the stable agrochemical composition prepared in microreactor processing system with narrow particle size distribution ranging from 200 nm to 350 nm, comprises from about 10% to about 50% by weight of glufosinate ammonium, from about 1% to about 50% by weight of haloxyfop-p-methyl, from about 1% to about 30% by weight of solvents and from about 1% to about 20% by weight of non-ionic and anionic surfactants.

Accordingly, the stable agrochemical composition prepared in microreactor processing system with narrow particle size distribution ranging from 200 nm to 350 nm, comprises from about 10% to about 50% by weight of glufosinate ammonium, from about 1% to about 50% by weight of haloxyfop-p-methyl, from about 1% to about 30% by weight of solvents and from about 1% to about 20% by weight of non-ionic and anionic surfactants is in the form of an Emulsion, oil in water formulation (EW).

According to the present invention the stable agrochemical compositions prepared in a microreactor processing system as described herein have particle size distribution ranging from 200 nm to 350 nm.

Advantageously the present composition is stable during storage at various temperature conditions e.g. ambient (25° C.), AHS (54° C.), 0° C. and also −5° C. (CIPAC MT 46.3 and MT 39.3) as well as upon end use while diluted with water.

According to an embodiment of the present invention, the present invention provides a method for controlling undesired plants or to influence the growth of plants, said method comprising applying to the plants or to their locus an effective amount of the composition prepared according to the present invention comprising
atleast one pesticide in oil phase; and
atleast another pesticide in aqueous phase,
   wherein said stable agrochemical composition having mean particle size distribution ranging from 200 nm to 350 nm, to the plants or to their locus.

According to an embodiment of the present invention, the method to control undesired plants or to influence the growth of plants, said method comprising applying to the plants or to their locus an effective amount of the composition comprising
atleast one herbicide in oil phase; and
atleast one herbicide in aqueous phase;
   wherein said stable agrochemical composition has narrow particle size distribution ranging from 200 nm to 350 nm, to the plants or to their locus and wherein said stable agrochemical composition is prepared in microreactor processing system.

In another embodiment, there is provided a method for weed control comprising applying to the plants, a composition according to the present invention comprising atleast one herbicide in oil phase; and atleast one herbicide dissolved in aqueous phase; wherein said stable agrochemical composition has narrow particle size distribution ranging from 200 nm to 350 nm and; wherein said stable agrochemical composition is prepared in microreactor processing system.

In a preferred embodiment of the present invention, there is provided a method for controlling harmful plants wherein said method comprises applying to the plants or to their locus an effective amount of the composition according to the present invention comprising glufosinate, other herbicide and/or other auxiliary ingredients, wherein said stable agrochemical composition has narrow particle size distribution ranging from 200 nm to 350 nm and; wherein said stable agrochemical composition is prepared in microreactor processing system.

In an aspect the present invention provides use of present stable agrochemical composition having particle size distribution ranging from 200 nm to 350 nm, prepared according to the present invention as herbicide to control harmful plants.

In an embodiment the present invention provides use of emulsion composition comprising glufosinate and or other herbicide and/or other auxiliary ingredients, wherein said emulsion is prepared in microreactor processing system having narrow particle size distribution ranging from 200 nm to 350 nm.

The abovementioned compositions provide effective weed control to keep agricultural crops free from undesired competing plants and thus to safeguard and/or increase the yields from the qualitative and quantitative point of view.

The compositions of the present invention maybe used to target weeds among the crops such corn, rice, wheat, barley, rye, oat, sorghum, cotton, soybean, peanut, buckwheat, beet, rapeseed, sunflower, sugar cane, tobacco, etc.; vegetables: solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit, olive, plum, banana, coffee, date palm, coconuts, etc., tea, nut and vine crops, crops such as coconut, coffee, cocoa trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

The target weeds may be selected from Alopecurus myosuroides Huds. (blackgrass, ALOMY), Amaranthus palmeri (Palmer amaranth, AMAPA) Amaranthus viridis (slender amaranth, AMAVI), Avena fatua (wild oat, AVEFA), Brachiaria decumbens Stapf or Urochloa decumbens (Stapf), Brachiaria brizantha or Urochloa brizantha, Brachiaria platyphylla (Groseb.) Nash or Urochloa platyphylla (broadleaf signalgrass, BRAPP), Brachiaria plantaginea. or Urochloa plantaginea (alexandergrass, BRAPL), Cenchrus echinatus (southern sandbur, CENEC), Digitaria horizontalis Willd. (Jamaican crabgrass, DIGHO), Digitaria insularis (sourgrass, TRCIN), Digitaria sanguinalis (large crabgrass, DIGSA), Echinochloa crus-galli (barnyardgrass, ECHCG), Echinochloa colonum (junglerice, ECHCO), Eleusine indica Gaertn. (goosegrass, ELEIN), Lolium multiflorum Lam. (Italian ryegrass, LOLMU), Panicum dichotomiflorum Michx. (fall panicum, PANDI), Panicum miliaceum L. (wild-proso millet, PANMI), Sesbania exaltata (hemp sesbania, SEBEX), Setaria faberi Herrm. (giant foxtail, SETFA), Setaria viridis (green foxtail, SETVI), Sorghum halepense (Johnsongrass, SORHA), Sorghum bicolor, Moench ssp., Arundinaceum (shattercane, SORVU), Cyperus esculentus (yellow nutsedge, CYPES), Cyperus rotundus (purple nutsedge, CYPRO), Abutilon theophrasti (velvetleaf, ABUTH), Amaranthus species (pigweeds and amaranths, AMASS), Ambrosia artemisiifolia L. (common ragweed, AMBEL), Ambrosia psilostachya DC. (western ragweed, AMBPS), Ambrosia trifida (giant ragweed, AMBTR), Anoda cristata (spurred anoda, ANVCR), Asclepias syriaca (common milkweed, ASCSY), Bidens pilosa (hairy beggarticks, BIDPI), Borreria species (BOISS), Borreria alata or Spermacoce alata Aubl. or Spermacoce latifolia (broadleaf buttonweed, BOILF), Chenopodium album L. (common lambsquarters, CHEAL), Cirsium arvense (Canada thistle, CIRAR), Commelina benghalensis (tropical spiderwort, COMBE), Datura stramonium (jimsonweed, DATST), Daucus carota (wild carrot, DAUCA), Euphorbia heterophylla (wild poinsettia, EPHHL), Euphorbia hirta or Chamaesyce hirta (garden spurge, EPHHI), Euphorbia dentata Michx. (toothed spurge, EPHDE), Erigeron bonariensis or Conyza bonariensis (hairy fleabane, ERIBO), Erigeron canadensis or Conyza canadensis (horseweed, ERICA), Conyza sumatrensis (tall fleabane, ERIFL), Helianthus annuus (common sunflower, HELAN), Jacquemontia tamnifolia (smallflower morningglory, IAQTA), Ipomoea hederacea (ivyleaf morningglory, IPOHE), Ipomoea lacunosa (white morningglory, IPOLA), Lactuca serriola (prickly lettuce, LACSE), Portulaca oleracea (common purslane, POROL), Richardia species (pusley, RCHSS), Salsola tragus (Russian thistle, SASKR), Sida species (sida, SIDSS), Sida spinosa (prickly sida, SIDSP), Sinapis arvensis (wild mustard, SINAR), Solanum ptychanthurn (eastern black nightshade, SOLPT), Tridax procumbens (coat buttons, TRQPR), Rumex dentatus (RUMDE) or Xanthium strumarium (common cocklebur, XANST).

In an embodiment, the formulation of the present invention may be applied to the locus either simultaneously or sequentially, such that the herbicide may be applied in a tank mix or as a pre-mixed composition.

In an embodiment, the present invention may be applied either pre or post emergent. The advantage of the combination/composition is surprisingly good residual effects, when applied in pre-emergent as well as quick knockdown when applied post emergent leading to quick control of weeds. In another embodiment, the present invention may be applied for quick burndown of weeds. Another advantage is quick knockdown in the case of burndown.

The method of control of the present invention may be carried out by spraying the suggested tank mixes, or the individual herbicides may be formulated as a kit-of-parts containing various components that may be mixed as instructed prior to spraying.

According to an embodiment of the present invention, there is provided a kit comprising said stable agrochemical composition as an herbicide to control harmful plants.

According to an embodiment of the present invention, the various components of the stable agrochemical composition can be used individually or already partially or completely mixed with one another to prepare the composition according to the invention. It is also possible to be packaged and used further as combination composition such as a kit of parts.

In one embodiment of the invention, the kits may include one or more, including all, components that may be used to prepare a stable agrochemical composition. E. g., kits may include active ingredients and/or auxiliary ingredients. One or more of the components may already be combined or formulated. In those embodiments where more than two components are provided in a kit, the components may already be combined and as such are packaged in a single container such as a vial, bottle, can, pouch, bag or canister.

In other embodiments, two or more components of a kit may be packaged separately, i. e., not pre-formulated. As such, kits may include one or more separate containers such as vials, cans, bottles, pouches, bags or canisters, each container containing a separate component for stable agrochemical composition.

In both forms, a component of the kit may be applied separately from or together with the further components or as a component of a combination composition according to the invention for preparing the stable liquid composition according to the invention.

In a preferred embodiment of the present invention, the stable agrochemical composition comprising atleast one pesticide in oil phase; and atleast one another pesticide in aqueous phase, wherein said stable agrochemical composition has narrow particle size distribution ranging from 200 nm to 350 nm; is in the form of a kit.

Inventors of the present invention succeeded in preparing advantageously stable agrochemical compositions comprising glufosinate, other herbicide and optionally other auxiliary ingredients, having narrow particle size distribution ranging from 200 nm to 350 nm. The compositions obtained according to the present invention has narrow particle size distribution are found to be stable at various temperature & conditions as well as effective for their intended biological activity.

In one embodiment the microreactor processing system for producing a stable agrochemical composition comprising glufosinate, other herbicide and optionally other auxiliary ingredients, is technically advanced over the conventional process.

The compositions prepared in microreactor processing system according to the present invention is obtained at a much faster rate than conventional methods and are reproducible.

The instant invention is more specifically explained by below examples. However, it should be understood that the scope of the present invention is not limited by the examples in any manner. It will be appreciated by any person skilled in this art that the present invention includes aforesaid examples and further can be modified and altered within the technical scope of the present invention.

The following examples demonstrate the preparation of stable oil-in-water emulsion compositions in accordance with the present invention.

### Example 1

An oil-in-water emulsion composition of Glufosinate Ammonium and S-Metolachlor was prepared as follows:

In a Vessel-1, 11.8 g S-metolachlor was dissolved in 12 g Solvesso 150 under stirring condition to obtain a mixture. Afterward, 0.5 g silwet L408, 1.5 g alkamul VO/2003 and 13.3 g soprophor 4D384 was subsequently added to the mixture under continuous stirring condition to obtain pre-formulated oil phase. In a Vessel-2, 27.6 g Glufosinate was dissolved in 33.3 ml water under stirring condition to obtain pre-formulated aqueous phase. The reaction vessel was set at a temperature 30±2° C. Pre-formulated oil phase in Vessel-1 (maintained at 30±2° C.) was fed to the reaction vessel by first mixing line at 3.75 ml/min. Pre-formulated aqueous phase in Vessel-2 (maintained at 30±2° C.) was fed to the reaction vessel by second mixing line at 6.25 ml/min. The reaction vessel was set at 1 bar pressure. Feeding pumps connected to mixing lines were switched on and; pre-formulated oil phase and pre-formulated aqueous phase was allowed to pass through first and second mixing lines respectively to the mixing reaction vessel. The reaction vessel was allowed to facilitate mixing of oil phase and aqueous phase in a continuous flow for about 3.84 second. The resulting oil-in-water emulsion composition was collected in vessel-3.

| Ingredients | Amount (% w/w) |
|---|---|
| Glufosinate Ammonium | 27.6 |
| S-metolachlor | 11.8 |
| Solvesso 150 | 12 |
| Silwet L 408 | 0.5 |
| Alkamul VO/2003 | 1.5 |
| Soprophor 4D384 | 13.3 |
| Water | Qs. |

### Example 2

An oil-in-water emulsion composition of glufosinate ammonium and haloxyfop-p-methyl was prepared as follows:

In a Vessel-1, 4 g haloxyfop-p-methyl was dissolved in 25 g aromatic C-9 under stirring condition to obtain mixture. Afterwards, 0.5 g silwet L408, 0.5 g tergitol XD, 3 g soprophore 4D384, 3.5 g soprophore BSU was subsequently added to the mixture under continuous stirring condition to obtain pre-formulated oil phase. In a Vessel-2, 27.6 g Glufosinate was dissolved in 47.5 ml water under stirring condition to obtain pre-formulated aqueous phase. The reaction vessel was set at a temperature 30±2° C. Pre-formulated oil phase in Vessel-1 (maintained at 30±2° C.) was fed to the reaction vessel by first mixing line at 3.5 ml/min. Pre-formulated aqueous phase in Vessel-2 (maintained at 30±2° C.) was fed to the reaction vessel by second mixing line at 6.5 ml/min. The reaction vessel was set at 1 bar pressure. Feeding pumps connected to mixing lines were switched on and; pre-formulated oil phase and pre-formulated aqueous phase were allowed to pass through first and second mixing lines respectively to the reaction vessel. Allow the reaction vessel to facilitate mixing of oil phase and aqueous phase in a continuous flow for about 3.84 second. The resulting oil-in-water emulsion composition was collected in vessel-3.

| Ingredients | Amount (% w/w) |
|---|---|
| Glufosinate Ammonium | 27.6 |
| Haloxyfop-P-methyl | 4.0 |
| Aromatic C-9 | 25 |
| Silwet L 408 | 0.5 |
| Tergitol XD | 0.5 |
| Soprophor 4D384 | 3.0 |
| Soprophor BSU | 3.5 |
| Water | Qs. |

### Example 3

An oil-in-water emulsion composition of glufosinate ammonium and oxyfluorfen was prepared as follows:

In a Vessel-1, 5 g Oxyfluorfen was dissolved in 20 g organic solvent including aromatic C-9 and Rhodiasolve ADMA 810 under stirring condition to obtain homogeneous solution. Afterwards, 0.5 g silwet L408, 1 g Atlox G-5000, 4 g soprophor BSU was subsequently added to the solution under continuous stirring condition to obtain pre-formulated homogeneous oil phase.

In a Vessel-2, 14 g Glufosinate ammonium was dissolved in 55.5 ml water under stirring condition to obtain pre-formulated aqueous phase. The reaction vessel was set at a temperature 30±2° C. Pre-formulated oil phase in Vessel-1 (maintained at 30±2° C.) was fed to the reaction vessel by first mixing line at 3.7 ml/min. Pre-formulated aqueous phase in Vessel-2 (maintained at 30±2° C.) was fed to the reaction vessel by second mixing line at 6.3 ml/min. The reaction vessel was set at 1 bar pressure. Feeding pumps connected to mixing lines were switched on and pre-formulated oil phase pre-formulated aqueous phase was allowed to pass through first and second mixing lines respectively to the reaction vessel. Allow the reaction vessel to facilitate mixing of oil phase and aqueous phase in a continuous flow for about 3.84 second. The resulting oil-in-water emulsion composition was collected in vessel-3.

| Ingredients | Amount (% w/w) |
|---|---|
| Glufosinate Ammonium | 27.6 |
| Oxyfluorfen | 5 |
| Solvesso 150 | 4 |
| ADMA 810 | 16 |
| Silwet L 408 | 0.5 |
| Atlox G5000 | 1.0 |
| Soprophor 4D384 | 4 |
| Water | Qs. |

### Example 4

An oil-in-water emulsion composition of glufosinate ammonium and s-Metolachlor was prepared as follows: (Comparative Example)

A homogenous solution was prepared by mixing 11.8 g S-Metolachlor, 12 g solvesso 150 under stirring condition. Afterwards, 0.5 g silwet L408, 1.5 g alkamul VO/2003 and 13.3 g soprophor 4D384 was subsequently added to the solution under continuous stirring condition to obtain pre-formulated homogeneous oil phase. Pre-formulated aqueous phase was prepared by dissolving 27.6 g Glufosinate ammonium in water under stirring condition and oil phase was transferred to aqueous phase slowly to get an EW emulsion.

| Ingredients | Amount (% w/w) |
|---|---|
| Glufosinate Ammonium | 27.6 |
| S-metolachlor | 11.8 |
| Solvesso 150 | 12 |
| Silwet L 408 | 0.5 |
| Alkamul VO/2003 | 1.5 |
| Soprophor 4D384 | 13.3 |
| Water | Qs. |

### Comparative Study of Particle Size Distribution

The stability of all the compositions were assessed after the stated time period at room temperature (RT) and 54° C. The samples were tested in a particle size analyzer (Malvern's Zeta Sizer) to measure the particle size of dispersed oil globules in the continuous phase.

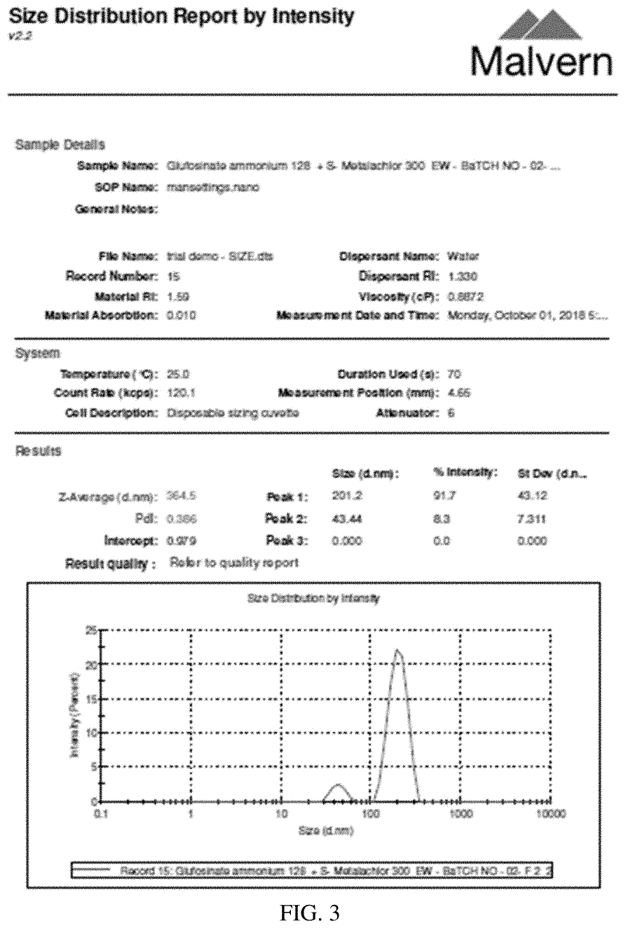

The stable agrochemical composition (Example 1) developed in a microreactor processing system according to the present invention was tested for particle size distribution. Same composition (Example 4) was prepared by a conventional process. It was observed that composition of Example 1 developed in microreactor processing system found to have excellent stability profile with respect to uniformity of the dispersion. 91.7% of particles in the composition of Example 1 found to have a mean particle diameter of about 201.2 nm which resulted into very stable emulsion (FIG. 3).

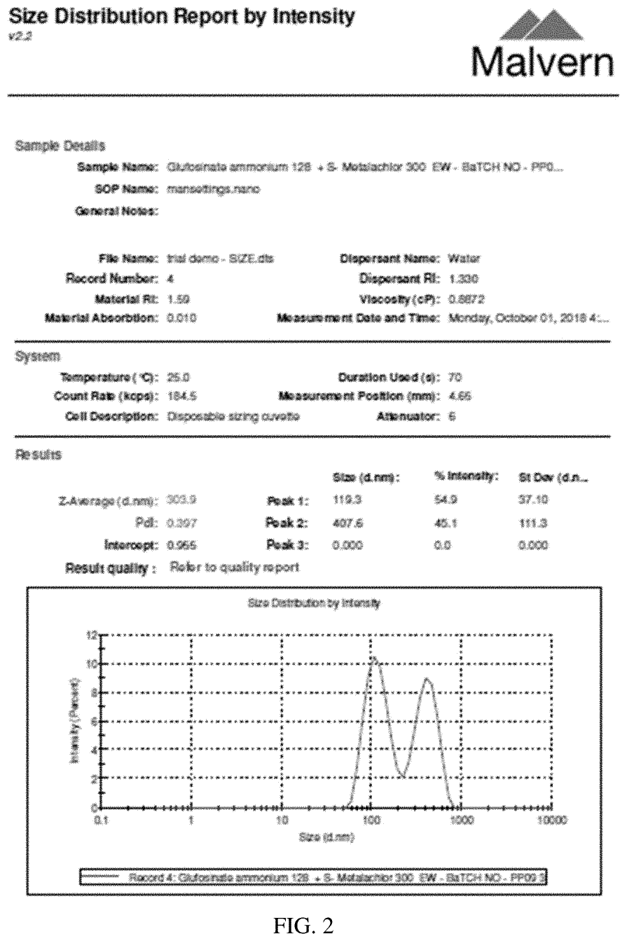

However, a wider particle size distribution was observed for the composition of Example 4 developed by conventional method. About 54.9% particles were found to have mean particle diameter of 119.3 nm and about 45.1% particles were found to have mean particle diameter of 407.6 nm (FIG. 2).

It was concluded that although Z-Average of both the compositions of Example-3 (Z-Average=303.9 nm) and Example-4 (Z-Average=364.5 nm) are within similar range but particle size distribution is drastically different being more narrower distribution in case of Example-1 which depicts uniformity of oil globules (dispersed particles); and more broader distribution in case of Example-4. Therefore, the composition developed in microreactor processing system having narrow particle size distribution found to be more stable than the composition prepared in conventional manner. The result of particle size distribution is presented below in Table 1.

TABLE 1

| | Mean Particle | Percent |
|---|---|---|
| Example(s) | Diameter (nm) | Intensity |
| Example (3) | 201.2 | 91.70% |
| Microreactor Process | 43.44 | 8.30% |
| Example (4) | 119.3 | 54.90% |
| Conventional Process | 407.6 | 45.10% |

Storage Stability of the Compositions

The stability of the compositions according to the present invention was tested as per CIPAC Methods 36.3. Table 2 shows the observations on storing the said stable agrochemical compositions at various temperature conditions e.g. ambient (25° C.), AHS (54° C.), 0° C. and also −5° C. (CIPAC MT 46.3 and MT 39.3). It has been observed that all the compositions (Example 1, 2 and 3) prepared in microreactor system remained quite stable throughout the study. The compositions prepared according to the present invention appeared as viscous stable emulsion with clear and uniform dispersion in all the four temperature conditions mentioned above. No creaming, flocculation or other instability related changes observed and the composition developed in micro-reactor system remained quite stable.

TABLE 2

| | Active | Appearance | Appearance | Appearance | Appearance |
|---|---|---|---|---|---|
| | Ingredients | at 25° C. | at 54° C. | at 0° C. | at −5° C. |
| Composition | (% w/w) | after 14 days | after 14 days | after 7 days | after 7 days |
| Example 1 | A - 27.6 | Viscous | Viscous | Viscous | Viscous |
| | C - 11.8 | stable | stable | stable | stable |
| | | emulsion | emulsion | emulsion | emulsion |
| Example 2 | A - 16 | Viscous | Viscous | Viscous | Viscous |
| | B - 4 | stable | stable | stable | stable |
| | | emulsion | emulsion | emulsion | emulsion |
| Example 3 | A - 14 | Viscous | Viscous | Viscous | Viscous |
| | D - 5 | stable | stable | stable | stable |
| | | emulsion | emulsion | emulsion | emulsion |

A = Glufosinate,
B = Haloxyfop-p-methyl,
C = S-Metolachlor,
D = Oxyfluorfen

Emulsion Stability on Dilution with Water

The compositions were further tested for their stability by observing the appearance of the oil-in water emulsions upon dilution (as per CIPAC MT 36.3) and the results are summarized in Table 3. The stability of said compositions were confirmed by observing them after dilution with water. The sample were checked for the stability parameters such as creaming and sedimentation. All the compositions prepared according to the present invention were found to be stable without any creaming or sedimentation when observed after 24 hours.

TABLE 3

| | Cream formation | Sedimentation | | |
|---|---|---|---|---|
| Composition | after 24 hrs (ml) | after 24 hrs | | Observation |
| Example 1 | Nil | 1 | ml | Stable |
| | | | | emulsion |
| Example 2 | Nil | 0.5 | ml | Stable |
| | | | | emulsion |
| Example 3 | Nil | 0.5 | ml | Stable |
| | | | | emulsion |

Therefore, the stable agrochemical composition was successfully prepared in the microreactor system. The composition in the form of an oil dispersion prepared according to the present invention passed stability tests and remained quite stable in various temperature conditions. Also, the oil dispersion found to be acceptable even upon dilution. It is to be understood that the invention is not to be limited to the details of the above embodiments, which are described by way of example only.

1. A process of preparing stable agrochemical composition in a microreactor processing system comprising: a) charging a pre-formulated oil phase comprising at least one pesticide to the microreactor; b) charging a pre-formulated aqueous phase comprising at least one another pesticide to the microreactor; and c) allowing mixing of the oil phase and the aqueous phase in a reaction vessel of the microreactor to obtain an agrochemical composition, wherein said composition has a particle size distribution ranging from 200 nm to 350 nm.

2. The process as claimed in claim 1, wherein the at least one pesticide in the oil phase is selected from the group consisting of triazolinone, N-phenylphthalimide, diphenyl ether, chloroacetanilide, aryloxyphenoxypropionic acid herbicide compounds, their equivalents, salts, esters, isomers, derivatives, ands combinations thereof.

3. The process as claimed in claim 2, wherein pesticide is selected from the group consisting of acifluorfen, chlomethoxyfen, fomesafen, oxyfluorfen, acetochlor, butachlor, metazachlor, metolachlor, S-metolachlor, pretilachlor, clodinafop, cyhalofop, fenoxaprop, haloxyfop, haloxyfop-P, haloxyfop-P methyl, quizalofop, quizalofop-P, amicarbazone, carfentrazone, flucarbazone and sulfentrazone, their equivalents, salts, esters, isomers, derivatives, and combinations thereof.

4. The process as claimed in claim 2, wherein said pesticide is selected from the group consisting of pyrimidinyloxybenzoic compounds, organophosphorous based compounds, bipyridinium compounds, imidazolinone herbicide compounds, their equivalents, salts, esters, isomers, derivatives, and combinations thereof.

5. The process as claimed in claim 1, wherein said at least one another pesticide in the aqueous phase is selected from the group consisting of bispyribac, pyriminobac, anilofos, bensulide, bilanafos, fosamine, glufosinate, L-glufosinate, glyphosate, imazamox, imazapic, imazapyr, imazaquin and imazethapyr, their equivalents, salts, esters, isomers, derivatives, and combinations thereof.

6. The process as claimed in claim 1, wherein pre-formulated oil phase is obtained by dissolving the at least one pesticide selected from the group of triazolinone compounds, N-phenylphthalimide compounds, diphenyl ether compounds, chloroacetanilide compound, aryloxyphenoxypropionic acid compounds their equivalents, metabolites, salts, esters, isomers and derivatives, and mixtures thereof in a solvent under continuous mixing; and optionally adding non-ionic and anionic surfactant and customary adjuvants.

7. The process as claimed in claim 1, wherein the pre-formulated aqueous phase is obtained by dissolving at least one herbicide selected from the group of pyrimidinyloxybenzoic compounds, organophosphorous based compounds, bipyridinium compounds and imidazolinone compounds, their equivalents, metabolites, salts, esters, isomers and derivatives, and mixtures thereof in water under continuous mixing to obtain the pre-formulated aqueous phase.

8. The process as claimed in claim 1, wherein said process is carried in a microreactor selected from the group consisting of a Plug Flow Reactor (PFR), a Continuous Stirred Tank Reactor (CSTR), a Loop reactor, a Packed Bed Reactor (PBR), and combinations thereof.

9. The process as claimed in claim 1, wherein a residence time for mixing the pre-formulated oil phase and the pre-formulated aqueous phase is in a range from about 10 seconds to 1 hour.

10. The process as claimed in claim 2, wherein the mixing is carried out at temperature in the range from about 10° C. to about 50° C. and pressure in a range from about 0.1 to about 20 bar.

11. The process as claimed in claim 1, wherein the pre-formulated oil phase is charged to the reactor at flow rate in the range from about 0.1 g/min to about 10 g/min.

12. The process as claimed in claim 2, wherein the pre-formulated aqueous phase is charged to the reactor at flow rate in a range from about 0.1 g/min to about 4000 g/min.

13. A stable agrochemical composition comprising at least one pesticide in an oil phase; and at least one another pesticide in an aqueous phase; wherein a mean particle size distribution of said composition ranges from 200 nm to 350 nm.

14. The composition as claimed in claim 13, wherein the at least one pesticide in the oil phase is selected from diphenyl ether, chloroacetanilide, and aryloxyphenoxypropionic acid herbicides; and the at least one another pesticide in the aqueous phase is selected from pyrimidinyloxybenzoic, organophosphorous and imidazoline herbicides.

15. The composition as claimed in claim 13, wherein the pesticide in the oil phase is selected from S-Metolachlor, haloxyfop-p-methyl and oxyfluorfen, and the another pesticide in the aqueous phase is glufosinate, glufosinate ammonium, L-glufosinate, or L-glufosinate ammonium.

16. The composition as claimed in claim 15, wherein said agrochemical composition is prepared in a microreactor processing system.

17. The composition as claimed in claim 15, wherein said composition is formulated as an oil in water emulsion (EW).

18. A method for controlling undesired plants or to influence the growth of plants comprising applying to the plants or to their locus an effective amount of the composition of claim 13.

19. The method as claimed in claim 18, wherein the at least one pesticide in the oil phase is selected from diphenyl ether, chloro acetanilide and aryloxyphenoxypropionic acid herbicides; and the at least one another pesticide in the aqueous phase is selected from pyrimidinyloxybenzoic, organophosphorous and imidazoline herbicides.
